(19) United States
(12) Patent Application Publication
(10) Pub. No.: US 2002/0191399 A1
(43) Pub. Date: Dec. 19, 2002

(54) Designed shell for christmas ornamental ball

(76) Inventor: Ming-Hsiung Chen, Taipei City (TW)

Correspondence Address: Richard P. Berg, Ladas & Parry, Suite #2100, 5670 Wilshire Boulevard, Los Angeles, CA, 90036-5679, US

(21) Appl. No.: 09/884,257

(22) Filed: Jun. 19, 2001

(51) Int. Cl. F21S 13/14

(52) U.S. Cl. 362/252

(57) ABSTRACT

A designed shell for Christmas ornamental ball having a plurality of linear ribs formed integral with the inside wall thereof subject to a predetermined design and separating the inside wall into a plurality of recessed spaces and a beyond-design area, the recessed spaces being surrounded by the linear ribs and respectively colored with light-penetrable color paints to show the predetermined design.

### BACKGROUND OF THE INVENTION

The present invention relates to a Christmas ornamental ball for use with a Christmas light set and, more specifically, to a designed shell for Christmas ornamental ball, which admits light and has integrated linear ribs, colored recessed spaces surrounded by the linear ribs to show a design, and frosted area beyond the design.

In addition to Christmas light sets, decorative balls 1 of different colors and designs may be used to decorate Christmas trees (see FIG. 1). These decorative balls 1 commonly have an outside wall electroplated with a color coating or painted with a particular design. Because these decorative balls are not designed to hold a lamp bulb on the inside, the coated colors and the designs of these decorative balls are indicative only when illuminated by external light source. There are also known these decorative balls that have a three-dimensional outer wall. When painting the three-dimensional outer wall, it is not easy to paint the predetermined design on desired positions and different color paints may be mixed. After coloring, black contour lines are drawn on the three-dimensional outer wall to show the contour of the design. This coloring procedure is complicated.

### SUMMARY OF THE INVENTION

It is one object of the present invention to provide a designed shell for Christmas ornamental ball, which uses integrated linear ribs to define a predetermined design, so that the coloring of the design is easy. It is another object of the present invention to provide a designed shell for Christmas ornamental ball, which uses linear ribs to separate adjacent areas of different colors, so that an outstanding three-dimensional design is presented when illuminated from the inside. It is still another object of the present invention to provide a designed shell for Christmas ornamental ball, which has the surface beyond the design defined by the linear ribs frosted so that the design surrounded by the linear ribs become apparent when illuminated. According to the present invention, designed shell comprises a plurality of linear ribs formed integral with the inside wall thereof subject to a predetermined design and separating the inside wall into a plurality of recessed spaces and a beyond-design area, the recessed spaces being surrounded by the linear ribs and respectively colored with light-penetrable color paints to show the predetermined design. The other area of the inside wall beyond the design defined by the linear ribs is frosted, so that the lamp suspended in the designed shell is kept from sight.

### BRIEF DESCRIPTION OF THE DRAWINGS

FIG. 1 illustrates decorative balls installed in a Christmas tree according to the prior art.

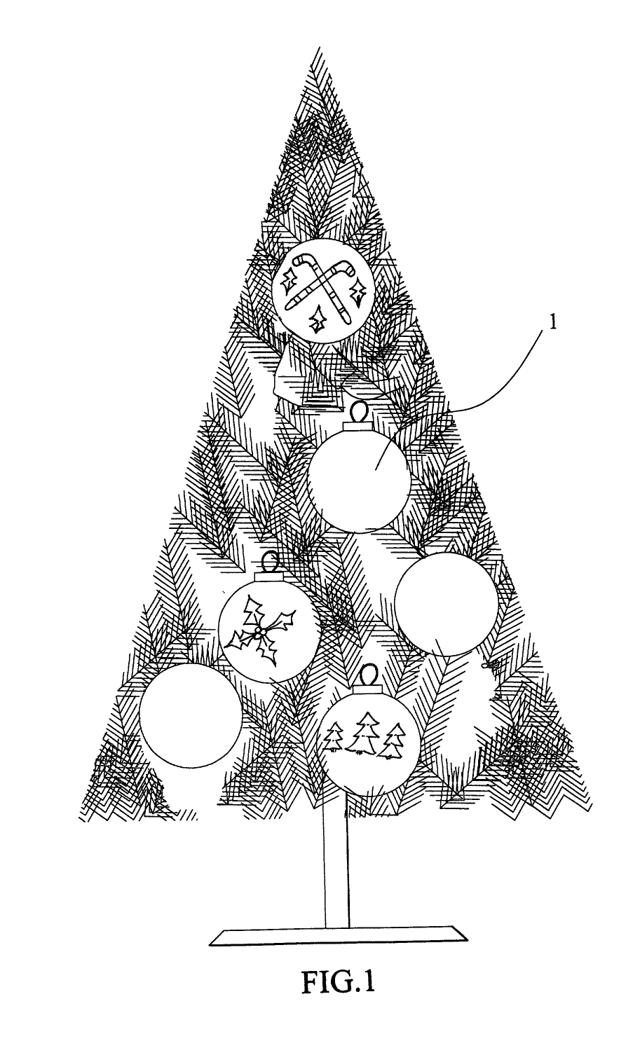

FIG. 2 is a perspective view of a Christmas ornamental ball constructed according to the present invention

FIG. 3 is a perspective view illustrating the structure of the designed shell according to the present invention.

FIG. 4 is a plain view of the designed shell according to the present invention.

### DETAILED DESCRIPTION OF THE PREFERRED EMBODIMENT

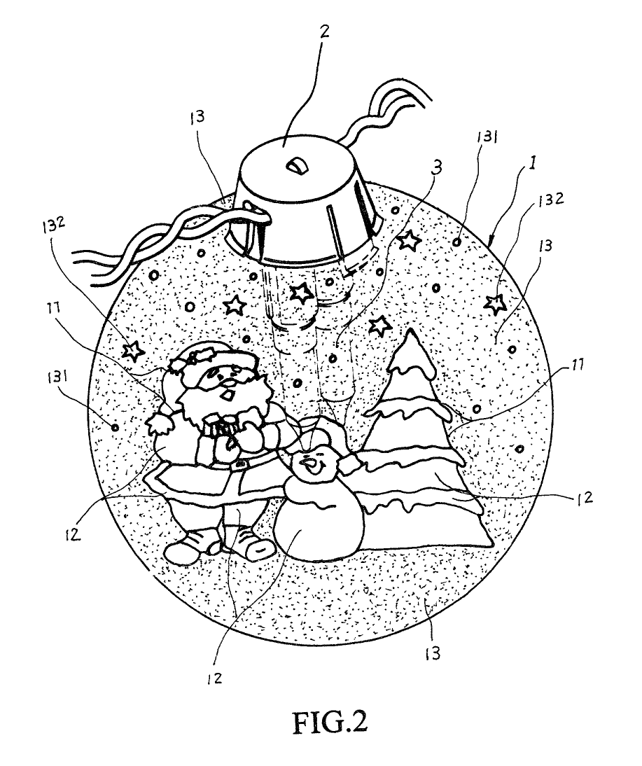

Referring to FIG. 2, a Christmas ornamental ball is designed for use with a Christmas light set to decorate a Christmas tree or the like, comprising a designed shell 1 having a circular opening 14 on the top, and a top cover 2 fastened to the circular opening 14 of the designed shell 1 to hold a lamp 3 in the designed shell 1. The designed shell 1 admits light. The lamp 3 is a part of a Christmas light set, and controlled to emit light through the designed shell 1.

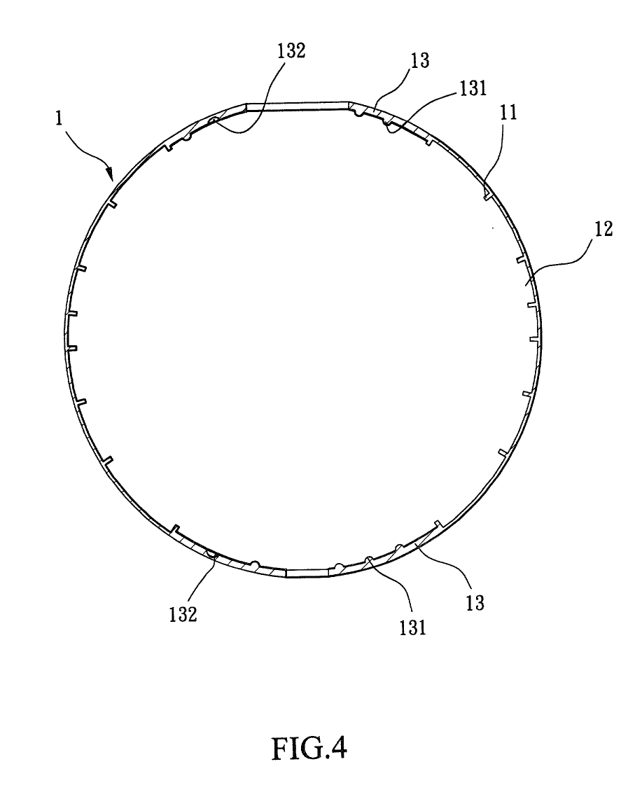

Referring to FIGS. 3 and 4 and FIG. 2 again, the designed shell 1 has linear ribs 11 formed integral with the inside wall thereof subject to a predetermined design, a plurality of recessed spaces 12 surrounded by the linear ribs 11. The recessed spaces 12 are respectively colored with light-penetrable color paints. The other area of the inside wall outside the linear ribs 11 is the beyond-design area 13, which is frosted. When turning on the lamp 3, the colored recessed spaces 12 are illuminated to show the design defined by the linear ribs 11, and the light passing through the frosted beyond-design area 13 of the designed shell 1 is dimmed, making a contrast against the illuminated design, and therefore an attractive lighting effect is produced.

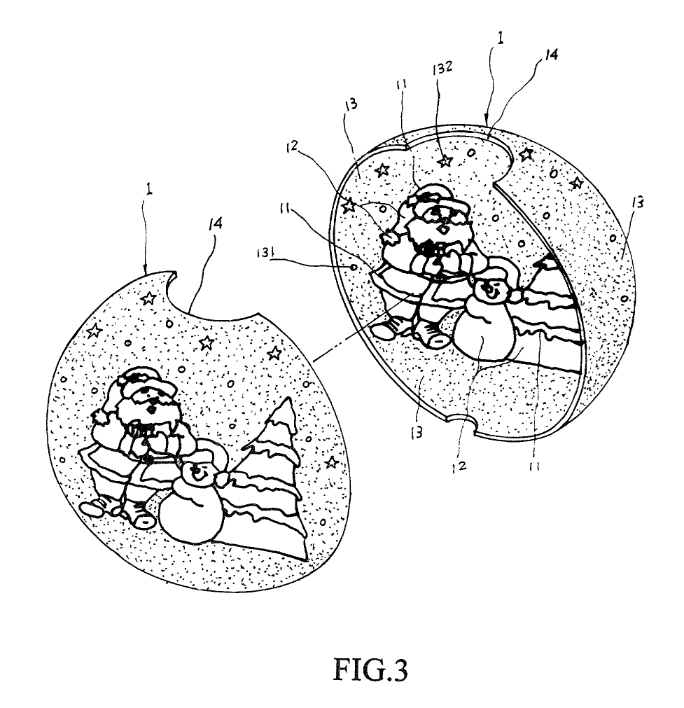

In FIG. 3, the linear ribs 11 show a design having a Santa Claus, a Christmas tree, and a Snowman between the Santa Claus and the Christmas tree. The linear ribs 11 may not be colored as for admitting better lighting effect, and therefore the contour lines of the design is fully lightened up when turning on the lamp 3. Further, raised portions 131 and recessed portions 132 are formed in the frosted beyond-design area 13 of the designed shell 1, simulating falling snowflakes and stars to decorate the design defined by the linear ribs 11.

A prototype of designed shell 1 for Christmas ornamental ball has been constructed with the features of FIGS. 2-4. The designed shell 1 for Christmas ornamental ball functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A designed shell for Christmas ornamental ball which admits light, comprising an inside wall, a plurality of linear ribs formed integral with said inside wall subject to a predetermined design and separating said inside wall into a plurality of recessed spaces and a beyond-design area, said recessed spaces being surrounded by said linear ribs and respectively colored with light-penetrable color paints to show said predetermined design.

2. The designed shell for Christmas ornamental ball of claim 1 wherein said linear ribs are not be colored with paint.

3. The designed shell for Christmas ornamental ball of claim 1 wherein said beyond-design area is frosted.

4. The designed shell for Christmas ornamental ball of claim 1 wherein said beyond-design area comprises a plurality of designed, raised portions and recessed portions.

5. A designed shell for Christmas ornamental ball which admits light, comprising an outside wall, a plurality of linear ribs formed integral with said outside wall subject to a predetermined design and separating said outside wall into a plurality of recessed spaces and a beyond-design area, said recessed spaces being surrounded by said linear ribs and respectively colored with light-penetrable color paints to show said predetermined design.
